(19) United States
(12) Patent Application Publication
(10) Pub. No.: US 2015/0266624 A1
(43) Pub. Date: Sep. 24, 2015

(54) Grocery Bag Reusable as a Garbage Bag

(71) Applicant: Craig L. Clodfelter, Phoenix, AZ (US)

(72) Inventor: Craig L. Clodfelter, Phoenix, AZ (US)

(21) Appl. No.: 14/494,593

(22) Filed: Sep. 24, 2014

Related U.S. Application Data
(60) Provisional application No. 61/881,878, filed on Sep. 24, 2013.

(51) Int. Cl. B65D 33/08; B65F 1/00

(52) U.S. Cl. CPC B65D 33/08; B65F 1/0006

(57) ABSTRACT

The embodied invention is a thin plastic garbage bag that is designed to be carried by three handles. Two handles are formed at the top edge, on opposite sides. A third handle is attached to the bottom of the bag, on the inside layer. For carrying groceries, the bottom handle is pulled upwardly to match the top two handles allowing the bag to become a three handled grocery bag. The bag is then supported in the middle and two sides, allowing for increased weight support. When the groceries are emptied, the bag is reused as a standard garbage bag by putting it into a garbage pail and dropping the lower edge all the way down. The bottom handle is no longer used. The bag is affordably made to any size garbage container.

### CROSS REFERENCE TO RELATED APPLICATIONS

This application claims the benefit of U.S. Provisional Application No. 61/88,1878, filed on Sep. 24, 2013. The entire provisional application is included by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This application is directed to the field of grocery bags, in particular, to bags that are recycled by using them for other purposes.

(2) Description of Related Art

Grocery bags are often made of plastic and cause a large environmental concern for disposal after use. Grocery bags are often used one time, and disposal efforts have been problematical as observed by the nature of litter on roadsides and landfills. Their light weight nature is a particular problem when they are blown by the wind. They accumulate on fences and brushes, and are a nuisance. Collection/recycle efforts have only partially solved this problem and other solutions are needed.

One possible solution is to recycle a grocery bag by finding another purpose for it after it is used, such designing it to be used for a dual purpose: a grocery bag and a garbage bag.

Others have worked on the possibility of using thermoplastic bags as carrying bags directly or indirectly. U.S. Pat. No. 5,029,926 discloses a paper handle that provides convenience for carrying a bag, and to reduce hand stress. However, this does not address the need for re-use.

Similarly, US 2012/008878 provides a secondary drawstring tie system at the bottom of a bag to provide a supporting method for carrying the bag. The intent is to provide a garbage bag with higher capacity and an ergonomic manner of carrying the bag.

U.S. Pat. No. 4,925,056 describes a special garbage container designed to re-use a grocery bag as a garbage bag. Though useful, it is an involved and customized design. The grocery bag itself lacks the ability to fit into existing standard containers already in use. Similarly, U.S. Pat. No. 8,240,621 is also customized container.

There is a lack in the art for a grocery bag that provides useful and convenient carrying capacity and is also designed to fit into existing garbage containers.

### BRIEF SUMMARY OF THE INVENTION

The embodied invention is a thin plastic garbage bag that is designed to be carried by three handles. Two handles are formed at the top edge, on opposite sides. A third handle is attached to the bottom of the bag, on the inside layer. For carrying groceries, the bottom handle is pulled upwardly to match the top two handles allowing the bag to become a three handled grocery bag. The bag is then supported in the middle and two sides, allowing for increased weight support. When the groceries are emptied, the bag is reused as a standard garbage bag by putting it into a garbage pail and dropping the lower edge all the way down.

The bottom handle is no longer used. The bag is affordably made to any size garbage container.

### BRIEF DESCRIPTION OF THE SEVERAL VIEWS OF THE DRAWING(S)

FIGS. 1A-1C show the bag design and how it is used as a grocery bag.

FIGS. 2A-2B shows how the bag looks when it is inserted into a garbage pail.

FIGS. 3A-3C show an embodiment of how the bag is formed into a three handled grocery bag.

### DETAILED DESCRIPTION OF THE INVENTION

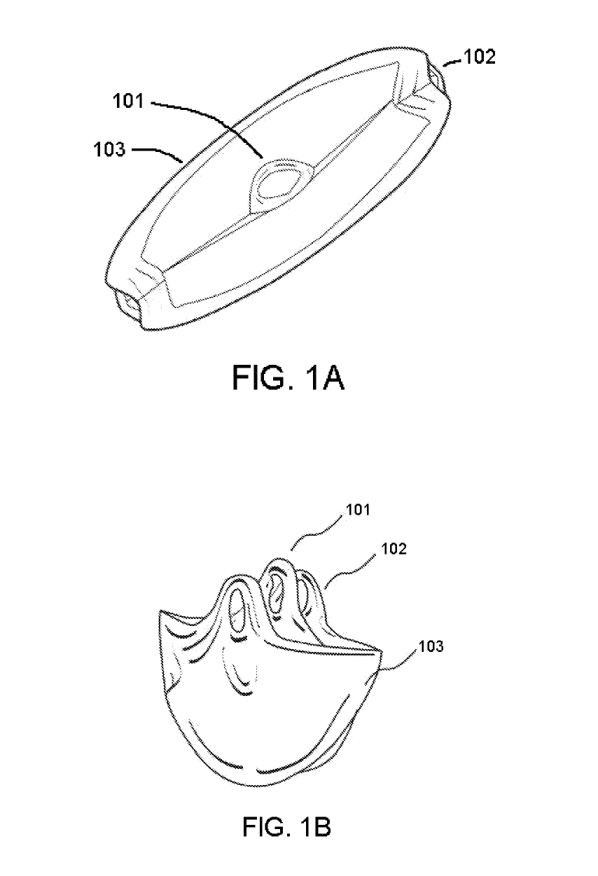

FIGS. 1A-1C show views of the dual use bag 103 when it is fully adapted into a grocery bag. As seen in the top view of FIG. 1A, the bottom handle 101 of the bag is located in the middle of the sealed end, inside the tube, and the two upper side handles 102 are readily available for use. In FIG. 1B, the bottom handle 101 is lifted upwardly so that the opening of the bottom handle 101 matches the opening of the upper handles 102 on the top of the bag. The bag is not turned ‘inside out’ as part of the conversion. The bottom is merely pulled up to the top. FIG. 1C show the bag as it is used as a carrying bag for groceries. The bag will be loaded with a central inside support created by the bottom handle 101 and the inside of the bag will be a donut shape.

The bag is especially useful as a grocery bag when all three handles are in line which creates the added benefit that the bag is capable of carrying a higher amount of weight due to the increased number of lifting handles. It is also useful as a garbage bag with a high volume capacity when inserted into a standard kitchen waste pail, preferably 13-15 gallons. The conversion between the two bags creates a dual use bag with different sizes with respect to the length downwardly from the handles. This is an important benefit.

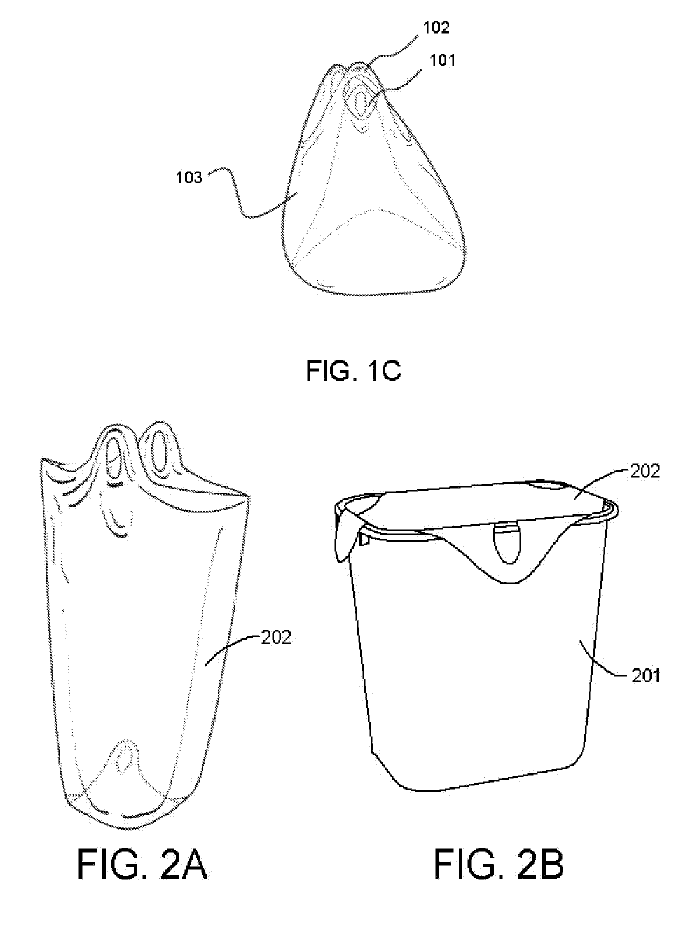

FIGS. 2A-2B shows the dual use bag 202 when inserted into a stiff garbage container 201 and how easily the bag is converted into a grocery carrying bag. The bottom handle is merely lowered, away from the top handles. The bottom handle is not used when the bag is used as a garbage bag.

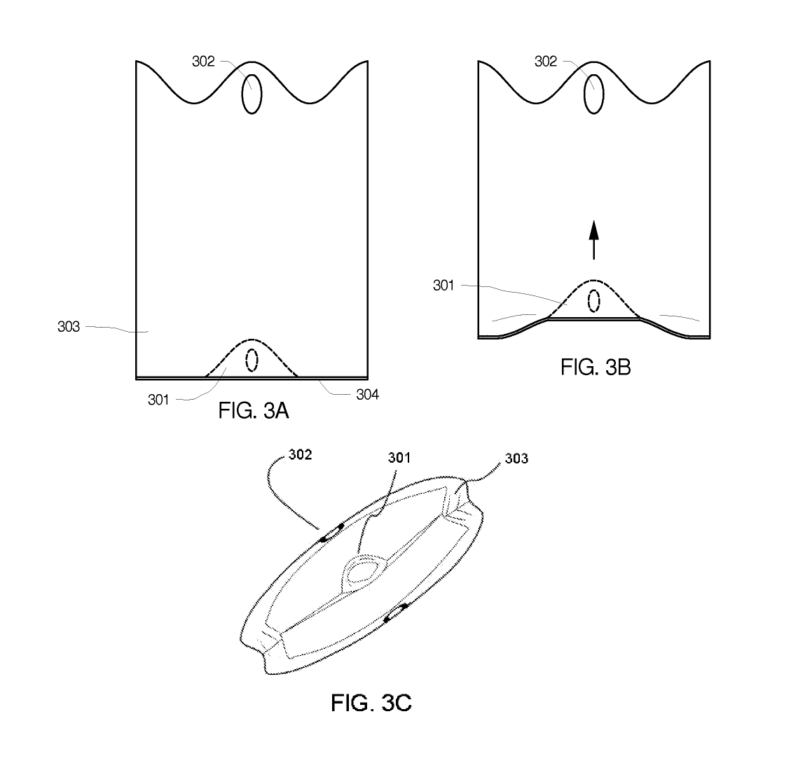

FIG. 3A is a side view of the dual use bag which is cut out from a tube and is flattened into two layers. The plastic is any material suitable for hauling groceries, such as a thermoplastic polyethylene or another polyolefin. Grocery and garbage bags are 0.5 to 3 mils thick. In FIG. 3A the bag is closed (sealed) at the bottom with a seam 304 and a bottom handle 301 attached to the bottom of the bag or integrated into the bottom seam 304. The bag 303 is a plastic tube of a uniform thickness which has been flattened as shown. Both the right and left edges are continuous from the top to the bottom layers to make the tube. The bag is formed from an initial uniform thickness plastic tube with a sealing seam added on the bottom and a cut made across the top to add the top handles. A pair of top handles 302, along with the bottom handle 301, are used to hold the bag and carry groceries. The top handles are also used to pull the bag out of the garbage pail for removal and disposal of waste. In FIG. 3C, a top view of the bag partially opened is shown.

The scallops which are cut across the top of FIGS. 3A-3B are only one embodiment of the invention. Other types of cut lines across the top could equally be used such as a straight line, an arc, a mixture of arcs and straight lines, and a pair of plastic film handles attached to the top edges, to name a few.

The dual use bag generally means that the bag is reused as a garbage bag after first being used as a grocery bag. It does not mean continual use; its use as a garbage bag is meant to be a one-time use as it is sent to the land fill, recycle facility, or other place. However, this is not a strict requirement.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A dual use bag useful as both a garbage bag and a grocery bag comprising:
a) a tube of plastic film of uniform thickness,
b) wherein said tube is sealed at one end,
c) a bottom handle, wherein said bottom handle is attached to said sealed end,
d) wherein said bottom handle is located inside said tube,
e) a plurality of upper handles incorporated into the end of said tube opposite of said sealed end, and
f) wherein said bottom handle is designed to be pulled upwardly to match said upper handles for the purposes of carrying groceries,
whereby said dual use bag is usable as a garbage bag inside a stiff garbage container after use as a grocery bag.
